(19) United States
(12) Patent Application Publication
(10) Pub. No.: US 2025/0021968 A1
(43) Pub. Date: Jan. 16, 2025

(54) CRYPTOGRAPHICALLY SECURE PHYSICAL CURRENCY

(71) Applicant: Wells Fargo Bank, N.A., San Francisco, CA (US)

(72) Inventors: Marc Ward, Livermore, CA (US); Thomas J. Gilheany, San Jose, CA (US)

(21) Appl. No.: 18/350,453

(22) Filed: Jul. 11, 2023

(51) Int. Cl. G06Q 20/38; G06Q 20/34

(52) U.S. Cl. CPC G06Q 20/3827; G06Q 20/341; G06Q 20/389; G06K 19/041

(57) ABSTRACT

This application describes techniques for authenticating and/or using a device as physical currency. In one example, this disclosure describes a device comprising: precious metal embedded within the device providing an intrinsic value for the device and making the device suitable for use as physical currency; and processing circuitry configured to: store information about a transaction hash associated with the device, wherein the transaction hash is derived from prior transactions performed using the device, and enable comparison of the transaction hash to information about the device that is stored on a distributed ledger.

### TECHNICAL FIELD

This disclosure relates to computer systems and, in particular, computing systems that authenticate and manage the circulation of payment cards.

### BACKGROUND

Electronic payments are now widespread, but physical currency (e.g., paper notes and coins) can still be used as a medium of exchange for goods and services. Physical currency is still convenient in some situations, especially where electronic funds are not accessible. Physical currency is typically backed by the government that issues it, which gives it a level of security and stability that other forms of currency may not have. Assets held or maintained by a financial institution, which is typically a private business, might be viewed as not having that same level of security.

### SUMMARY

This application describes techniques for using a device as physical currency. In some examples, techniques described involve manufacturing, distributing, placing into circulation, and use of physical currency devices, where the devices are often in the form of credit card-sized cards. In most examples, some amount of precious metal is embedded within the card, giving the card a Value. The cards may be designed to allow the users to engage in transactions by using the cards as physical currency in a secure manner and in conjunction with electronic payments, accounting, and funds management features. In some examples, a user (or merchant) that owns or at least possesses such a card may follow a procedure to validate the card, which may involve a smart contract executing on a blockchain or consensus network. Such a validation process enables implementation of certain recordkeeping, security, and other features associated with the card. In some cases, the validation process updates records stored in a distributed ledger, and also updates information stored on the card itself.

In some examples, both precious metal (providing an intrinsic value) and processing circuitry (providing computing capabilities) are embedded within each card. As the card is used in transactions, a transaction hash stored in the card is updated for each new transaction. A corresponding transaction hash is stored in a distributed ledger maintained by a consensus network. Attempts to counterfeit the card may be identified when inconsistencies arise in the distributed ledger.

In some examples, this disclosure describes operations performed by a computing system in accordance with one or more aspects of this disclosure. In one specific example, this disclosure describes a method comprising embedding precious metal within a device, thereby providing the device with an intrinsic value and making the device suitable for use as physical currency; storing, within the device, information about a transaction hash associated with the device, wherein the transaction hash is derived from prior transactions performed using the device; detecting an indication of a new transaction; and comparing the transaction hash to information about the device that is stored on a distributed ledger.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF DRAWINGS

FIG. 1A is a conceptual diagram illustrating an example system in which users and merchants use a device for payment, in accordance with one or more aspects of the present disclosure.

FIG. 1B is a block diagram illustrating an example physical currency device or card, in accordance with one or more aspects of the present disclosure.

FIG. 2 is a conceptual diagram and block diagram illustrating an example transaction network in which cards or devices are used for physical currency, in accordance with one or more aspects of the present disclosure.

FIG. 3 is a flow diagram illustrating example operations of a transaction network regulating precious metal cards, in accordance with techniques of this disclosure.

FIG. 4 is a flow diagram illustrating operations performed by an example computing system in accordance with one or more aspects of the present disclosure.

### DETAILED DESCRIPTION

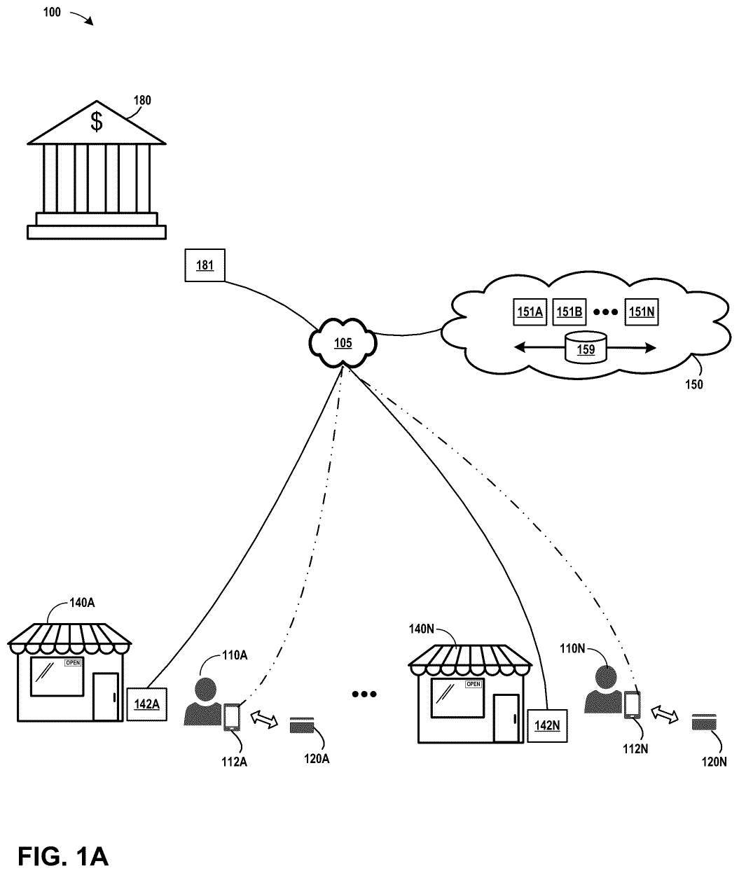

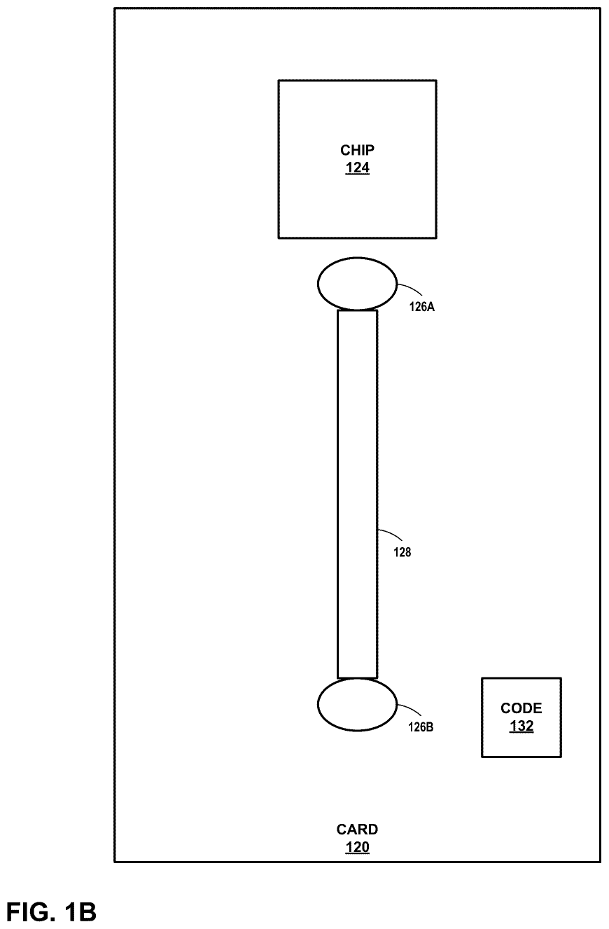

FIG. 1A is a conceptual diagram illustrating an example system in which users and merchants use a device for payment, in accordance with one or more aspects of the present disclosure. In FIG. 1A, transaction network 100 includes representation of any number of users, entities, and systems capable of communicating over network 105. For example, illustrated in transaction network 100 are users 110A through 110N (collectively, “users 110,” representing any number of users), merchants 140A through 140N (collectively, “merchants 140,” representing any number of merchants), and network administrator 180. Also illustrated in FIG. 1A is a blockchain or consensus network 150, which may manage the distribution, verification, and/or use of various devices 120A through 120N (collectively, “devices 120” or “cards 120,” representing any number of such devices or cards).

Each of users 110 may operate and/or possess one or more computing devices 112. For example, as illustrated in FIG. 1A, user 110A operates computing device 112A and, in general, user 110N operates computing device 112N. Users 110 may communicate and/or interact with other users 100, merchants 140, and network administrator 180 (e.g., over network 105) using such computing devices 112. Network 105 serves as a communications infrastructure or platform on which transaction network 100 operates. Network 105 may be or may include or represent any public or private communications network or other network, including the internet.

Often, computing devices 112 may be mobile communications devices, such as smartphones. However, computing devices 112 may be implemented through any suitable computing system including any mobile, non-mobile, wearable, and/or non-wearable computing device, which may be a mobile phone or tablet, or a laptop or desktop computing device. In general, computing devices 112 may take any appropriate form, which may include a computerized watch, a computerized glove or gloves, a personal digital assistant, a virtual assistant, a gaming system, a media player, an e-book reader, a television or television platform, a bicycle, automobile, or navigation, information and/or entertainment system, or any other type of wearable, non-wearable, mobile, or non-mobile computing device that may perform operations in accordance with one or more aspects of the present disclosure.

Each of devices 120 may serve as physical currency, and in most examples illustrated herein, such devices 120 have a size or form similar to a common credit card. Cards 120 may be issued by network administrator 180, which is an entity that may manufacture or commission the manufacture of such cards 120. Network administrator 180 may place cards 120 in circulation for use as currency, which may involve distributing cards 120 to users 110.

Consensus network 150 may regulate details and ownership of cards 120 when in use within transaction network 100. Consensus network 150 may manage transactions between users 110 and merchants 140 involving the cards 120. One example implementation of a card 120 is illustrated in FIG. 1B.

Each of merchants 140 may be a physical, virtual, and/or online retailer or other commercial entity that provides products or services to users 110. For example, any of merchants 140 may be a grocery store, gas station, department store, specialty or other retailer, drug store, restaurant, coffee shop, medical clinic, legal or accounting services provider, transportation services provider, or any other commercial entity that maintains a physical presence. Alternatively, or in addition, any of merchants 140 may be an online or virtual commercial entity that provides products or services corresponding to or similar to those provided by a physical grocery store, gas station, department store, specialty or other retailer, drug store, restaurant, coffee shop, medical clinic, legal or accounting services provider, transportation services provider, or other commercial entity.

Merchants 140 may operate or control various computing systems, depicted generally in FIG. 1A as merchant computing systems 142A through 142N (collectively, “merchant computing systems 142”). Specifically, in FIG. 1A, merchant 140A operates and controls merchant computing system 142A, and merchant 140N operates or controls merchant computing system 142N. Each of merchant computing systems 142 performs operations relating to providing goods or services to one or more users 110 over network 105 or through physical delivery of a product sold by a corresponding merchant 140. For example, each of merchant computing systems 142 may perform operations that include manifesting a web presence, taking orders, providing product support, and/or communicating with customers.

Each of merchant computing systems 142 may be implemented as any suitable computing system or collection of computing systems, including one or more server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a data center, cloud computing system, server farm, and/or server cluster.

Network administrator 180 may be a public or private entity that administers operations on transaction network 100, monitors and maintains aspects of transaction network 100, and/or implements policies on transaction network 100 that tend to benefit users 110 and/or merchants 140. In some examples, network administrator 180 may be a bank or other financial institution, but other private or public entities could serve as network administrator 180. However, a bank or other financial institution may be an appropriate entity to serve as network administrator 180, since at least some banks and/or financial institutions tend to be well positioned (commercially, organizationally, and legally) to circulate physical currency, process transactions for merchants 140, and maintain financial accounts for users 110 in a way that facilitates operations on transaction network 100.

Network administrator 180 may operate and control a collection of computing systems for use in facilitating various network operations described herein. Such computing systems are collectively represented in FIG. 1A as network management computing system 181. Network management computing system 181 may be implemented as any suitable computing system or collection of computing systems, including one or more server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a data center, cloud computing system, server farm, and/or server cluster.

Consensus network 150 includes a plurality of nodes, including node 151A through 151N (collectively “nodes 151,” and representing any number of nodes). Consensus network 150 may include one or more distributed ledgers, including distributed ledger 159, which may be implemented as a data store included in multiple (or all) nodes 151 within consensus network 150. In general, each node 151 within consensus network 150 (or a significant fraction of nodes 151) includes a copy (or at least a partial copy) of distributed ledger 159 maintained by consensus network 150.

Typically, consensus network 150 is implemented as a network of computing devices (e.g., “nodes 151”) that collectively maintain one or more distributed ledgers 159. Nodes 151 included within consensus network 150 may each represent any computing device capable of adhering to a consensus protocol and/or performing operations corresponding to one or more smart contracts. One or more consensus networks 150 may, for instance, represent an Ethereum network of Ethereum virtual machines (EVMs), also known as an Ethereum blockchain platform, executing on hardware computing devices. In one example, consensus network 150 might be implemented as a proof of stake network, where network administrator 180 owns all the delegates and serves as a trusted source such that network administrator 180 settles all the blocks (e.g., through network management computing system 181). Consensus network 150 may be implemented in any appropriate manner, whether now known or hereinafter developed.

Distributed ledger 159 included within consensus network 150 may represent one or more shared transactional databases or data stores that include a plurality of blocks, each block (other than the root) referencing at least one block created at an earlier time, each block bundling one or more transactions registered within distributed ledger 159, and each block cryptographically secured. Consensus network 150 may receive transactions from transaction senders (e.g., computing devices external or internal to consensus network 150, such as network management computing system 181 in FIG. 1A) that invoke functionality of distributed ledger 159 (or of a smart contract) to modify distributed ledger 159 stored within and maintained by consensus network 150. Consensus network 150 may use distributed ledger 159 for verification. Each block of distributed ledger 159 may contain a hash pointer as a link to a previous block, a timestamp, and the transaction data for the transactions. In a blockchain implementation, and by design, distributed ledger 159 is inherently resistant to modification of previously-stored transaction data. Functionally, distributed ledger 159 serves as a ledger, distributed across many nodes of a consensus network, that can record transactions (and other information, generally) between parties efficiently and in a verifiable and permanent way. Since distributed ledger 159 is a distributed ledger, each of nodes 151 within consensus network 150 (or at least a significant fraction of nodes 151) store a copy of distributed ledger 159.

For ease of illustration, only one consensus network 150 is illustrated in FIG. 1A, and within consensus network 150, one distributed ledger 159 is illustrated. However, multiple consensus networks 150 may be included within implementations corresponding to that illustrated in FIG. 1A, and multiple distributed ledgers 159 might be included or implemented by one or more consensus networks 150 in a manner consistent with the techniques described herein. For example, consensus network 150 may manage multiple distributed ledgers 159. Further, each of distributed ledgers 159 might be a private distributed ledger or a public distributed ledger.

In an example that can be described in the context of FIG. 1A, and in accordance with one or more aspects of the present disclosure, network management computing system 181 may receive information about a card to be used in a transaction. For instance, computing device 112A detects input that it interprets as a request, by user 110A, to perform a transaction with merchant 140A. Computing device 112A accesses information about card 120A, which is in the possession of user 110A. To access information about card 120A, computing device 112A interacts with processing circuitry embedded within computing device 112A (e.g., using a wireless protocol) to determine an identification code associated with card 120A. Computing device 112A also interacts with card 120A to determine a transaction hash stored within card 120A. Computing device 112A outputs information about card 120A over network 105. Network management computing system 181 receives the information and determines that the information includes the identification code and the transaction hash associated with card 120A.

Network management computing system 181 may determine whether to allow card 120A to be used in a transaction. For instance, still referring to FIG. 1A, network management computing system 181 interacts with one or more nodes 151 on consensus network 150. In some examples, distributed ledger 159 maintains a current transaction hash for each of cards 120, including card 120A. Such a transaction hash reflects, for each card 120, information about prior transactions that have taken place using a given card. Network management computing system 181 provides the nodes 151 the identification code for card 120A, and one or more nodes 151 of consensus network 150 responds with the transaction hash stored in distributed ledger 159 maintained by consensus network 150. Network management computing system 181 compares the transaction hash received from computing device 112A (reflecting the transaction hash stored on card 120A) to the transaction hash received from nodes 151 (reflecting the transaction hash stored by distributed ledger 159). If the transaction hash information from card 120A is not consistent with the transaction hash information stored in distributed ledger 159, network management computing system 181 may deny the transaction, since such an inconsistency reflects a problem with card 120A (e.g., card 120A may be counterfeit). In some examples, such inconsistencies may result in a fork being created in distributed ledger 159, representing two different sequences of transaction hashes. However, if the transaction hash information from card 120A is consistent with the transaction hash information stored in distributed ledger 159, network management computing system 181 normally will allow the transaction to proceed.

Network management computing system 181 may store information about the transaction. For instance, again referring to the example being described in the context of FIG. 1A, if network management computing system 181 authorizes the transaction, computing device 112A and merchant computing system 142A thereafter interact to carry out the transaction. User 110A physically gives card 120A to a representative for merchant 140A in exchange for goods (or services) that user 110A is purchasing from merchant 140A. Since card 120A itself has intrinsic value, at least by virtue of the precious metal embedded within card 120A, card 120A serves as physical currency for the transaction, similar to how cash can be used in a transaction. Accordingly, user 110A takes possession of the purchased goods from merchant 140A. After the transaction, and after taking possession of the purchased goods, user 110A leaves card 120A with merchant 140A. As part of the transaction, and typically before the transaction is completed, computing device 112A and/or merchant computing system 142A communicate with network management computing system 181 to reconcile any difference between the value of the goods purchased from merchant 140A and the value of card 120A.

In another example that can be described in the context of FIG. 1A, network management computing system 181 may manage transactions involving cards 120 via consensus network 150 to validate the authenticity of cards 120. For example, network administrator 180 may distribute card 120A to user 110A. Prior to network administrator 180 distributing card 120A, network administrator 180 may use network management computing system 181 to hash one or more details of card 120A (e.g., weight and purity of precious metal embedded in the card, details of a universal integrated circuit card embedded in the card, a unique identifier associated with a quick response code or barcode embedded the card, an image of the card, etc.) in consensus network 150. Network management computing system 181 may store a hashed value representing the one or more details of card 120A within the distributed ledger 159 that is maintained by one or more nodes 151 of consensus network 150. Network management computing system 181 may also store another hashed value representing account information of user 110A that received card 120A. In addition, network management computing system 181 may encrypt one or more details of card 120A on a chip (e.g., a universal integrated circuit card) embedded on card 120A.

In some instances, computing device 112A may independently and remotely confirm the authenticity of card 120A. For example, an application executing on computing device 112A may detect input that it determines is a request (e.g., by user 110A) to perform an authentication of card 120A. In response to the input, the application executing on computing device 112A causes computing device 112A to output a signal specifying a request for network management computing system 181, via network 105, to confirm the authenticity of card 120A. The request may also indicate that one or more other cards 120 managed by the application and/or otherwise registered to user 110A are to be authenticated. Network management computing system 181 detects the signal over network 105. Network management computing system 181 determines that the signal corresponds to a request to authenticate card 120A (and others, in some examples). Network management computing system 181 interacts with one or more nodes 151 of consensus network 150. In some examples, such interactions may involve invoking a smart contract executing on nodes 151 of consensus network 150. As a result of the interactions, nodes 151 store information about card 120A in distributed ledger 159 maintained by consensus network 150. Consensus network 150 may thereafter recognize card 120A as authenticated for use by computing device 112A (e.g., operated by user 110A).

Computing device 112A, for example, may communicate with a chip (e.g., a universal integrated circuit card) embedded in card 120A through any form of wired connection (e.g., universal serial bus) or wireless connection (e.g., near field communication). In some examples, card 120A may include an input port, enabling power to be provided to the chip embedded in card 120A with a magnetic charging cable. In instances involving merchant 140A receiving card 120A as payment, merchant computing systems 142 may be equipped with a power source that can power the chip embedded in card 120A. In response to card 120A connecting to computing device 112A, card 120A may connect to network 105—and subsequently to consensus network 150—using the networking capabilities of the chip embedded in card 120A or of computing device 112A. Card 120A may also include cryptography capabilities embedded in the chip to enable encrypted communication between a smart contract executing on consensus network 150 and the chip embedded in card 120A. In some instances, card 120A may enable encrypted communication between a smart contract executing on consensus network 150 and card 120A through the application executing on computing device 112A. Card 120A may use the encrypted communication channel to interact with a smart contract executing on the consensus network 150, such as by sending details about card 120A (e.g., where those details are hashed into the chip embedded in card 120A).

In some examples, computing device 112A may capture an image of card 120A—via a camera included in computing device 112A, for example. Computing device 112A may output a signal to consensus network 150 via network 105. One or more nodes 151 of consensus network 150 may receive the signal, and use information included in the signal (e.g., the image) to identify card 120A and/or process the request to authenticate card 120A.

Consensus network 150 may process the request to authenticate card 120A by reviewing information about the card 120A that are encrypted on the chip and the image of card 120A. Both the information and the image may be received from an application executing on computing device 112A (e.g., after card 120A establishes communication with computing device 112A) or the chip embedded in card 120A. Consensus network 150 may process the request to authenticate card 120A through a smart contract executing on consensus network 150. The smart contract executing on consensus network 120 may compare the one or more details of card 120A stored in the distributed ledger 159 to the one or more details encrypted on the chip of card 120A. One or more nodes 151 of consensus network 150 may have image processing capabilities, which may be used by such nodes 151 to analyze any visual indications of the authenticity of card 120A. Such analysis may be based on the image of card 120A received by one or more nodes 151 on consensus network 150. Consensus network 150 may also analyze the metadata of the image of card 120A to determine when the image was captured (e.g., the image was taken shortly after nodes 151 received the request to authenticate card 120A).

In response to consensus network 150 determining the one or more details of card 120A stored in distributed ledger 159 managed by consensus network 150 match the one or more details of card 120A encrypted on the chip embedded in card 120A, consensus network 150 may generate a transaction hash associated with the request to authenticate card 120A. In response to consensus network 150 generating the transaction hash, consensus network 150 may store the transaction hash in the distributed ledger 159 (which may involve nodes 151 reaching consensus about such changes).

The smart contract executing on the consensus network 150 may also instruct, via the encrypted communication with card 120A over network 105, the chip embedded in card 120A to update the data storage of the chip with the new transaction hash. For example, consensus network 150 may output a signal that includes the new transaction hash. In some instances, consensus network 150 may encrypt the new transaction hash within the signal. Card 120A may use the networking capabilities of the chip embedded in card 120A to receive the encrypted signal via network 105. In some instances, computing device 112A may receive the encrypted signal via network 105. Computing device 112A may relay the encrypted signal to card 120A via the connection with card 120A (e.g., via a universal serial bus connection or near field communication). Card 120A may receive the encrypted signal and decrypt the signal with the chip embedded in card 120A, thereby revealing the new transaction hash. Card 120A updates the data storage of the chip embedded in card 120A with the new transaction hash included in the signal. Once card 120A updates the data storage of the chip embedded in card 120A with the new transaction hash, card 120A may terminate communication with consensus network 150.

In response to card 120A being authenticated by consensus network 150, consensus network 150 may send, via network 105, a confirmation to the application executing on computing device 112A indicating that card 120A has been authenticated or verified. Computing device 112A may send the confirmation to other computing devices 112 or merchant computing systems 142 with the application executing on computing device 112A. Merchant computing system 142A may, for example, receive the confirmation via an application executing on merchant computing system 142A. Consensus network 150 may also store the outcome of the authentication process in distributed ledgers 159 by embedding information about the outcome of the transaction in distributed ledger 159. Storing such information may allow distributed ledger 159 to reliably track information about authentication attempts (e.g., the number of authentication attempts, when the authentications occurred, etc.), which may be used assess validity of the card and attempts to undermine such validity.

Although discussed primarily with respect to card 120A in the possession of user 110A, the techniques described herein may apply to other devices and/or users illustrated herein, including any of computing devices 112, computing systems 142, cards 120, users 110, and merchants 140.

Techniques described herein may provide certain technical advantages. For instance, updating the chip embedded in distributed cards 120 with unique transaction hashes during each authentication serves as a counterfeiting defense. If a bad actor or other unauthorized user obtains one or more cards 120 and attempts to use such cards 120, consensus network 150 may recognize inconsistencies with prior transactions (e.g., the same key is used for multiple cards, differing transaction hashes). Consensus network 150 may respond to such inconsistencies by creating a fork in distributed ledger 159, reflecting that, for example, the same key encrypted on the chip of a specific card 120 (e.g., card 120A) is used on multiple cards. In such a situation, further use of card 120A could be disabled, and not allowed to be updated with a new transaction or authentication hash. Even if a bad actor is able to successfully authenticate and/or use a counterfeit of card 120A in a transaction, consensus network 150 will eventually identify inconsistencies in distributed ledger 159. Network management computing system 181 may take action, such as by flagging, for review, any card purporting to be card 120A. Network management computing system 181 may also disable card 120A from being verified and/or authenticated to prevent potential the counterfeit of card 120A from being authenticated or otherwise used in a transaction.

FIG. 1B is a block diagram illustrating an example physical currency device or card, in accordance with one or more aspects of the present disclosure. In the example of FIG. 1, card 120 may be physically tamper-resistant (e.g., during manufacturing, network administrator 180 may apply tamper-resistant sealant to enclose the components embedded in card 120). Card 120 may include chip 124 (e.g., universal integrated circuit card, subscriber identity module, etc.) used to store authentication and encryption information as described herein. Card 120 of FIG. 1B may correspond to card 120A of FIG. 1A, for example.

Card 120 may also include a precious metal strip 128, which may comprise any appropriate precious metal (e.g., gold, silver, etc.), and which provides card 120 with an intrinsic value, so that card 120 is suitable for use as physical currency. It is typically possible to embed a tenth of an ounce of precious metal into a credit card-sized device, which may correspond to an intrinsic value on the order of a few hundreds of dollars of United States currency. Other amounts of precious metal could be used in a card, including a one hundredth of an ounce, larger fractions of an ounce, or any other appropriate amount for a given device. Although conventional currency typically involves use of precious metal refined to bullion-level purity, precious metal strip 128 need not be refined to that level of purity. Instead, strip 128 may include precious metal refined to a purity that is typically considered less than bullion, or below 0.9999.

In accordance with the techniques described herein, card 120 may be connected to a power source to provide power to chip 124. Precious metal strip 128 may be connected to the power source and chip 124, and may be used to provide power to components of card 120. For example, card 120 may be connected to a power source with a magnetic charging cable or via metallic contacts embedded on card 120. In some instances, chip 124 may be induction powered via an internal coil and a resulting magnetic field (e.g., powered via near field communication, radio frequency identification technology, etc.). Card 120 uses power for various purposes, including to power chip 124 and/or to communicate with other devices, such as one or more computing devices 112 or merchant computing systems 142. In some examples, merchant computing system 142A may have a magnetic charging cable or metallic contacts that may provide card 120 with power. In such an example, merchant computing system 142A furnishes power that allows merchant computing system 142A to validate, or participate in the validation of, card 120.

Chip 124 may include encryption capabilities that enable secure communication with consensus network 150 via network 105 (and often, also via another device, such as one of computing devices 112 or merchant computing systems 142). For example, merchant computing system 142A may send a signal to network management computing system 181, via network 105, to request that card 120 be authenticated. In some instances, network management computing system 181 may receive the signal and process the request. In other instances, network management computing system 181 may relay the signal to consensus network 150 via network 105. Consensus network 150 may execute a smart contract associated with card 120, resulting in a signal being sent back to merchant computing system 142A prompting merchant 140A to connect merchant computing system 142A to chip 124 of card 120. Merchant computing system 142A may connect to chip 124 through, for example, near field communication or with a universal serial bus connection. When merchant computing system 142A connects to chip 124, merchant computing system 142A may send information hashed on chip 124 (e.g., identification code, transaction hash) to consensus network 150, via network 105 and network management computing system 181. Consensus network 150 may authenticate card 120 based on whether consensus network 150 determines the information stored on chip 124 is consistent with the corresponding information stored in distributed ledger 159. Consensus network 150 may utilize compute and network resources of network management computing system 181 to process the request to authenticate card 120.

The purity and/or other attributes of the precious metal embedded within card 120 can be tested and/or verified using known methods, which often involve a chemical evaluation of the precious metal. In some instances, card 120 may include diodes 126A and 126B (collectively referred to as “diodes 126”) which may enable another way for the precious metal strip 128 to be tested or evaluated. In other words, it may be possible to test or analyze strip 128 by applying electrical current to precious metal strip 128 from an appropriate power source (e.g., magnetic charging cable). In some cases, such a power source may include the power source used to power chip 124 during the authentication process discussed above. For example, diodes 126 may be connected in series with an anode of diode 126A connected to a cathode of diode 126B. Precious metal strip 128 may be connected to the junction between diodes 126. Once power is supplied to diodes 126, an electrical current runs through precious metal strip 128. Attributes of the current can be analyzed in order to test the purity of the precious metal of precious metal strip 128. In some examples, chip 124 may be connected to diodes 126, and may collect information about the electrical current running through precious metal strip 128 between diodes 126. Chip 124 may also measure a voltage of diode 126A and a voltage of diode 126B to determine a voltage drop caused by the precious metal of precious metal strip 128, for example. In some examples, chip 124 may measure a magnetic field or any other measurable effects produced by the electrical current running through precious metal strip 128. Chip 124 may be configured to communicate information about the electrical current to other systems (e.g., network management computing system 181 or consensus network 150).

In some examples, card 120 may include additional circuit components that may be used to provide card 120 with a unique physical signature. For example, card 120 may include any combination of diodes, resistors, capacitors, etc. to generate a unique signature for card 120. Card 120 may be associated with a unique signature that is generated by any well-known techniques (e.g., single-signature or dual-signature power device technology as described in IEEE 802.3bt, physically unclonable functions, etc.). Chip 124 may be configured to communication information about the unique signature to other systems (e.g., network management computing system 181 or consensus network 150).

In some instances, attributes of precious metal strip 128 may be analyzed to verify the authenticity, purity, and/or integrity of precious metal strip 128 and/or card 120. For example, chip 124 or another device may, during a test of precious metal strip 128, determine the current flowing through precious metal strip 128 (or alternatively the voltage drop across precious metal strip 128). Information about such attributes or measured values may be evaluated (e.g., by network management computing system 181 or by a smart contract executing on consensus network 150). Such a smart contract and/or network management computing system 181 may compare the measured values (e.g., current or determined voltage drop) to expected values for the precious metal strip 128 for a specific card. In some examples, network management computing system 181 may store information about the attributes (or cause such values to be stored in distributed ledger 159) prior to distributing card 120.

If a later evaluation of card 120 results in attributes that are substantially the same as the stored values, the evaluation supports a conclusion that card 120 has not been modified or counterfeited. Such an evaluation may take into account that properties of diodes 126 and precious metal strip 128 may be change over time due to temperature, degradation, and other factors. If a later evaluation of card 120 does not result in attributes (current values, voltage drop values) that are substantially the same as the stored values, that may indicate that the card 120 has been modified or is counterfeit.

In some examples, card 120 may also include an identification code 132, which may be used by network management computing system 181 and/or consensus network 150 to verify or authenticate card 120. In some examples, code 132 may be embedded in memory or within processing circuitry included within card 120, and accessible electronically. Alternatively, or in addition, code 132 may be printed on the face of card 120 as a quick response (QR) code or any other appropriate code designed to provide a unique identifier for card 120. Where the code is visible, a computing device 112 and/or merchant computing system 142 may capture an image of card 120 and send the image, via network 105, to network management computing system and/or consensus network 150 as part of a process of verifying and/or authenticating card 120. Network management computing system 181 and/or consensus network 150 may analyze code 132 during such a verification process.

In some instances, code 132 may serve to uniquely identify card 120. Further, the code 132 can be used by other systems to access information about an account linked to a specific card 120. In such instances, computing devices 112 allow users 110 to link an external account to card 120. For example, when user 110A receives card 120—either through initial circulation or as a result of a transaction—that user may use computing device 112A (or another computing device 112) to associate a bank account or cryptocurrency wallet with that card. In some examples, network management computing system 181 may prompt user 110A, via an application executing on computing device 112A operated by user 110A, to link an external account to card 120 prior to generating an authentication or transaction hash. Network management computing system 181 may delete any linking information associated with an external account at appropriate times, such as when possession of card 120 has changed (e.g., used in a transaction).

Card 120 may also include a transaction hash (not specifically shown), which may be stored in a memory device included within chip 124. The transaction hash may be initialized when card 120 is placed in circulation, and thereafter updated each time card 120 is used in a transaction. Typically, the same transaction hash (or a corresponding transaction hash) is stored in the distributed ledger maintained by consensus network 150. In some cases, the code 132 and the transaction hash can be stored together, as part of the same code. In such an example, the code changes with each transaction, but is capable of serving as both a unique identifier for the card 120 and a transaction hash that represents all prior transactions in which the card has been used.

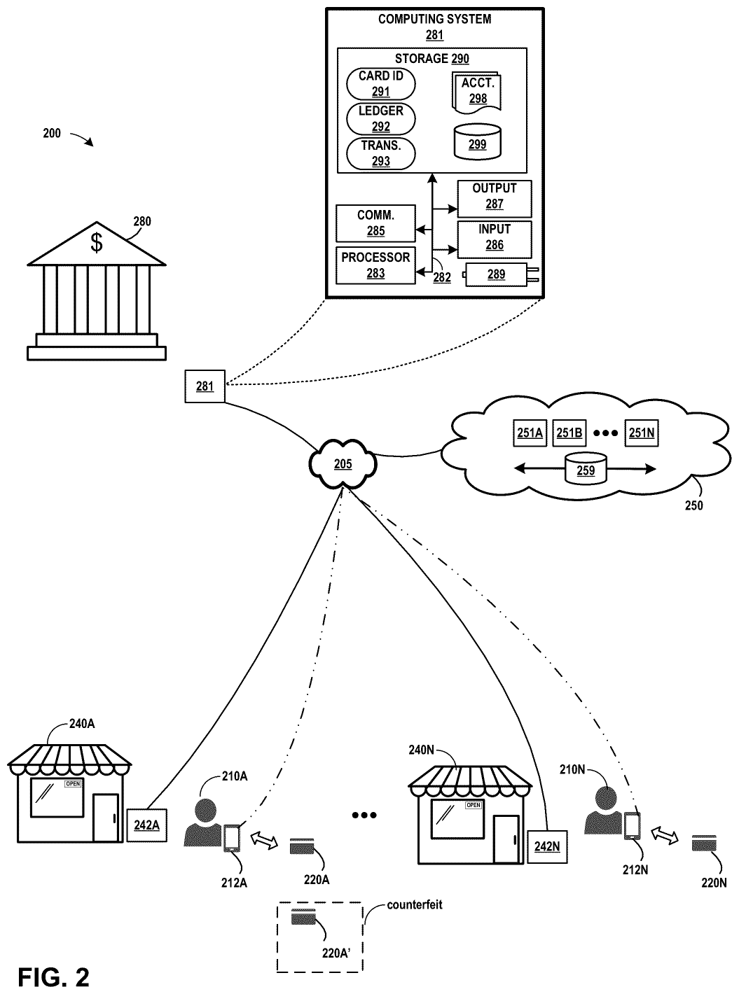

FIG. 2 is a conceptual diagram and block diagram illustrating an example transaction network in which devices are used for physical currency, in accordance with one or more aspects of the present disclosure. Transaction network 200 of FIG. 2 includes many of the same elements of transaction network 100 of FIG. 1A. In FIG. 2, various elements may correspond to or may serve as examples of similar elements illustrated in FIG. 1A. For example, in FIG. 2, network administrator 280 and computing system 281 may correspond to network administrator 180 and network management computing system 181 of FIG. 1, respectively. Similarly, network 205, consensus network 250, nodes 251, and distributed ledger 259 may correspond to network 105, consensus network 150, nodes 151, and distributed ledger 159, respectively. Also, merchants 240, merchant computing systems 242, users 210, computing devices 212, and cards 220 may correspond to merchants 140, merchant computing systems 142, users 110, computing devices 112, and cards 120, respectively. In general, like-numbered elements illustrated in FIG. 2 correspond to element similarly illustrated and numbered in FIG. 1.

Further information relating to communicating information about the social behavior of users and transactions, which may be used in the context of examples described or mentioned herein, are available in U.S. patent application Ser. No. 18/153,189, filed Jan. 11, 2023 (entitled “Self-Disclosed Identity on a Network”), which is hereby incorporated by reference. Further information relating to automated escrow contracts, which may be used in the context of examples described or mentioned herein, are available in U.S. Provisional Patent Application No. 63/256,495, filed Oct. 15, 2021 (entitled “COMMODITY DELIVERY CONTRACT WITH AUTOMATED ESCROW CONTRACT), and U.S. patent application Ser. No. 17/827,387, filed May 27, 2022 (and entitled “COMMODITY DELIVERY CONTRACT WITH AUTOMATED ESCROW CONTRACT”). The entire content of both of these applications is hereby incorporated by reference.

FIG. 2 illustrates computing system 281 as a block diagram with specific components and data modules. As described, computing system 281 may correspond to, or may be considered an example or alternative implementation of network management computing system 181 of FIG. 1A. For ease of illustration, computing system 281 is depicted in FIG. 2 as a single computing system. However, in other examples, computing system 281 may comprise multiple devices or systems, such as systems distributed across a data center or multiple data centers. For example, separate computing systems may implement the functionality performed by identity module 291, ledger module 292, and/or transaction module 293. Alternatively, or in addition, computing system 281 (or various modules illustrated in FIG. 2 as included within computing system 281) may be implemented through distributed virtualized compute instances (e.g., virtual machines, containers) of a data center, cloud computing system, server farm, and/or server cluster.

In FIG. 2, computing system 281 is illustrated as including underlying physical hardware that includes power source 289, one or more processors 283, one or more communication units 285, one or more input devices 286, one or more output devices 287, and one or more storage devices 290. Storage devices 290 may include identity module 291, ledger module 292, and/or transaction module 293, user accounts 298, and data store 299. One or more of the devices, modules, storage areas, or other components of computing system 281 may be interconnected to enable inter-component communications (physically, communicatively, and/or operatively). In some examples, such connectivity may be provided by through communication channels, which may include a system bus (e.g., communication channel 282), a network connection, an inter-process communication data structure, or any other method for communicating data.

Power source 289 of computing system 281 may provide power to one or more components of computing system 281. One or more processors 283 of computing system 281 may implement functionality and/or execute instructions associated with computing system 281 or associated with one or more modules illustrated herein and/or described below. One or more processors 283 may be, may be part of, and/or may include processing circuitry that performs operations in accordance with one or more aspects of the present disclosure. One or more communication units 285 of computing system 281 may communicate with devices external to computing system 281 by transmitting and/or receiving data, and may operate, in some respects, as both an input device and an output device. In some or all cases, communication unit 285 may communicate with other devices or computing systems over network 205 or over other networks.

One or more input devices 286 may represent any input devices of computing system 281 not otherwise separately described herein, and one or more output devices 287 may represent any output devices of computing system 281 not otherwise separately described herein. Input devices 286 and/or output devices 287 may generate, receive, and/or process output from any type of device capable of outputting information to a human or machine. For example, one or more input devices 286 may generate, receive, and/or process input in the form of electrical, physical, audio, image, and/or visual input (e.g., peripheral device, keyboard, microphone, camera). Correspondingly, one or more output devices 287 may generate, receive, and/or process output in the form of electrical and/or physical output (e.g., peripheral device, actuator).

One or more storage devices 290 within computing system 281 may store information for processing during operation of computing system 281. Storage devices 290 may store program instructions and/or data associated with one or more of the modules described in accordance with one or more aspects of this disclosure. One or more processors 283 and one or more storage devices 290 may provide an operating environment or platform for such modules, which may be implemented as software, but may in some examples include any combination of hardware, firmware, and software. One or more processors 283 may execute instructions and one or more storage devices 290 may store instructions and/or data of one or more modules. The combination of processors 283 and storage devices 290 may retrieve, store, and/or execute the instructions and/or data of one or more applications, modules, or software. Processors 283 and/or storage devices 290 may also be operably coupled to one or more other software and/or hardware components, including, but not limited to, one or more of the components of computing system 281 and/or one or more devices or systems illustrated or described as being connected to computing system 281.

Identity module 291 may perform functions relating to identifying devices and/or cards used as physical currency, placing such devices and/or cards into circulation, and supporting efforts to verify devices and/or cards. Ledger module 292 may perform functions relating to interacting with or monitoring consensus network 250 or any other consensus network included within or used by transaction network 200. Transaction module 293 may perform functions relating to processing transactions taking place on transaction network 200, such as transactions between any of users 210 and any of merchants 240 or between any number of users 210. Transaction module 293 may generate transaction hashes or receive transaction hashes generated by a smart contract generated by nodes 251 of consensus network 250.

Accounts module 298 of computing system 281 may represent any suitable data structure or storage medium for storing information relating to accounts maintained for users 210, biometric and other information associated with users 210, information about transactions taking place on transaction network 200, and other information pertaining to the administration of transaction network 200 of FIG. 2 or other aspects of transaction network 200. The information stored in accounts module 298 may be searchable and/or categorized such that one or more modules within computing system 281 may provide an input requesting information from accounts module 298, and in response to the input, receive information stored within accounts module 298. Accounts module 298 may be primarily maintained by transaction module 293.

In some examples, some or all aspects of computing system 281 may be implemented as one or more nodes 251 on consensus network 250. Although illustrated and described herein as a separate system, computing system 281 may be a node on consensus network 250, or aspects of computing system 281 may implemented by one or more nodes 251 of consensus network 250. In other examples, computing system 281 may be a computing system capable of interacting with nodes 251 of consensus network 250 and thereby update distributed ledger 259 maintained by consensus network 250.

Modules illustrated in FIG. 2 (e.g., identity module 291, ledger module 292, and/or transaction module 293) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

In an example that can be described in the context of FIG. 2, and in accordance with one or more aspects of the present disclosure, network administrator 280 may distribute and/or circulate cards 220. For instance, network administrator 280 manufactures, or commissions the manufacture of, a plurality of cards 220. In some examples, each of cards 220 are nearly identical, with the same amount of precious metal embedded in them. In addition, each of cards 220 is equipped with the same or virtually the same processing circuitry (e.g., the same system on a chip).

Cards 220 may differ in some respects, however, in that each may have slightly different amounts of precious metal, due to variances in manufacturing. For example, some cards 220 may also differ from other cards 220 when precious metal embedded in cards 220 are mined from different geographic regions. In other words, different mines may produce different levels of precious metal purity, resulting in some cards 220 being manufactured so that the precious metal embedded within those cards has a composition that is at least slightly different than the composition of precious metal in other cards.

Also, each of cards 220 may have a unique identifier associated with, stored in, and/or embedded within the processing circuitry of each respective card 220. Such a unique identifier may be printed on the card (e.g., a Quick Response code or “QR” code), may be stored within memory included within the card, may be encoded within a secure enclave within processing circuitry or within a system on a chip (“SoC”) included within the card, and/or may otherwise be associated with or embedded within the card. In some examples, network management computing system 181 and/or consensus network 150 may authenticate card 120 by using the unique identifier as a public key and other authentication information described herein as a private key.

Still further, in some examples, network administrator 280 (or another entity that issues cards 220) may manufacture and/or circulate different value cards. For example, it may be appropriate and/or convenient to circulate a high value version and a low value version of cards 220, which may be particularly useful for a card or device that acts as physical currency. In such an example, each card might be intended to have a significantly different value (e.g., different amount or type of precious metal) to facilitate transactions of different amounts. The rationale for different values of cards 220 would be roughly the same rationale for the United States issuing currency in different values, such as $50 and $100 bills.

Network administrator 280 may distribute cards 220. For instance, again referring to the example being described with reference to FIG. 2, network administrator 280 places each of cards 220 in circulation. In examples where network administrator 280 is a bank, network administrator 280 may be in a convenient position to circulate cards 220, since it can exchange cash, currency, or other stores of value held by its customers with a card 220, similar to how a government-issued physical currency is placed into circulation. As a result of the circulation of cards 220, each of cards 220 may be owned and/or possessed by one of users 210. For example, card 220A may be possessed (or owned) initially by user 210A, and card 220N may be possessed initially by user 210N.

Each of cards 220 have an intrinsic value, at least due to the precious metal embedded within each card 220. Accordingly, a person owning or possessing each card can use the card as a physical currency, similar to cash. In addition, each of cards 220 could be configured to hold other forms of intrinsic value. In one such example, one or more cards 220 may be configured to own or otherwise have rights to a form of cryptocurrency, which may entitle the person possessing the card to the cryptocurrency owned by or associated with the card.

In connection with circulation of cards 220 to users 210, computing system 281 may receive various details about each of cards 220. For instance, again referring to FIG. 2 and with specific reference to card 220A being placed into circulation, input device 286 of computing system 281 detects input and outputs information about the input to identity module 291. Identity module 291 determines that the input corresponds to information about card 220A being placed into circulation. Identity module 291 further determines that the input includes certain details about card 220A. Such details may include information about purity of each of cards 220, an initial transaction hash value (e.g., for new cards, an initial transaction seed, which may reflect that the card has no prior transactions), any information about whether the card itself owns or has rights to some form of cryptocurrency or transaction fees on the network, or other related information. In some examples, such details may include the current or initial owner of each of cards 220.

Computing system 281 may update distributed ledger 259 to reflect information about each of cards 220. For instance, with reference to the example being described in the context of FIG. 2, identity module 291 outputs information about card 220A to ledger module 292. Ledger module 292 causes communication unit 285 to communicate with consensus network 250 over network 205. One or more nodes 251 on consensus network 250 determine that the communications correspond to a request to store information about card 220A on distributed ledger 259 maintained by consensus network 250. At least one of the nodes 251, such as node 251A, communicates with other nodes 251 on consensus network 250 pursuant to a consensus protocol. Node 251A causes (or initiates a process that causes) nodes 251 to reach consensus about proposed updates to distributed ledger 259. Eventually, nodes 251 within consensus network 250 update distributed ledger 259 to include information about card 220A, including one or more details about card 220A. In some examples, the details about card 220A stored on distributed ledger 259 could include any or all of the details referenced in the preceding paragraph. Computing system 281 may perform a similar process for each of cards 220. Accordingly, distributed ledger 259 may, for each of cards 220, include information about an identification code associated with each card 220 and information about the current (or initial) transaction hash associated with each card 220 (e.g., where the transaction hash reflects or is derived from information from all prior transactions performed using the card).

Computing system 281 may receive information about card 220A in response to user 210A seeking to use card 220A perform a transaction. For instance, again referring to the example being described in the context of FIG. 2, computing device 212A detects input that it determines corresponds to a request, by user 210A, to purchase goods from merchant 240A. Computing device 212A interacts with card 220A, which typically would be in the possession of user 210A (e.g., held in the user's hand). In some examples, computing device 212A interacts with processing circuitry on card 220A to access an identifying code associated with user 210A. In other examples, computing device 212A may capture an image of card 220A (or an image of a QR code or other identifying information printed on card 220A), and use the image to determine the identification code associated with card 220A. Computing device 212A outputs a signal over network 205. Communication unit 285 of computing system 281 detects a signal over network 205 and outputs information about the signal to transaction module 293. Transaction module 293 determines that the signal corresponds to a request to perform a transaction using card 220A. Transaction module 293 further determines that the signal includes both an identification code and any transaction hash read from card 220A. In the example being described, the identification code may be embedded within the card (e.g., stored within memory or embedded within processing circuitry) or may be printed on the card (e.g., a QR code). In other examples, the identification code and the transaction hash may be combined or stored together in some way so that a single code, encrypted token, or other data structure may be sufficient to both identify the card and serve as a hash of prior transactions associated with card 220A. In examples where card 220A is newly in circulation and has no prior transactions (or in other situations), the transaction hash associated with card 220A may be an initial code, a default code, or some other code that can be used to represent the history of transactions (or the lack thereof) associated with card 220A.

In some examples, the user may seek to use card 220A pursuant to a digital escrow contract governing the transaction. For example, the user may use card 220A is as a form of compensation (e.g., similar to cash) by the buyer when performing the transaction contemplated by the escrow contract. The escrow contract may be arranged or established by the parties to the transaction prior to a physical meeting during which the transaction takes place (i.e., where goods/services are exchanged for payment). In such an example, card 220A may be offered as payment by the buyer and identified in the digital escrow contract. Card 220A may enable the seller identified in the digital escrow contract, for example, to verify ownership of card 220A before the seller accepts card 220A as part of the transaction. According to the techniques described herein, when the buyer physically transfers card 220A to the seller (or prior to such a transfer), card 220A may be validated and/or authenticated by the seller before the seller takes possession of card 220A according to the terms of the escrow contract. Such a process may also enable network administrator 280 (or others) to track physical currency (e.g., identity and amounts of cards 220) being exchanged in the secondary marketplace (e.g., peer to peer transactions between users 210).

Computing system 281 may determine whether card 220A is legitimate. For instance, still continuing with the example, transaction module 293 of computing system 281 uses the identification code (or similar information) to identify card 220A. Transaction module 293 outputs information about card 220A to ledger module 292. Ledger module 292 communicates with one or more nodes 251 on consensus networks 250 to access information stored within distributed ledger 259 about the identified card. In response, one or more nodes 251 output information over network 205. Communication unit 285 of computing system 281 detects a signal and outputs information about the signal to transaction module 293. Transaction module 293 determines that the signal corresponds to information about the transaction hash for card 220A stored on distributed ledger 259. Transaction module 293 compares the transaction hash received from computing device 212A to the information about the transaction hash from distributed ledger 259. If the transaction hash information received from user 210A and stored within distributed ledger 259 are consistent (e.g., the same or based on the same information), transaction module 293 determines that card 220A is legitimate, and can be used to perform a transaction.

Computing system 281 may identify other information about card 220A or separately request other information about card 220A that has been stored in distributed ledger 259. In some examples, transaction module 293 may determine that the signal received from consensus network 250 also includes additional information about card 220A. Such additional information may include information about purity of the precious metal embedded on card 220A, cryptocurrency associated with card 220A, ownership information for card 220A, and/or other aspects of card 220A. In other examples, transaction module 293 may cause computing system 281 to separately request information about card 220A, where such a request may seek information about the purity, value, and/or other attributes of the precious metal embedded within card 220A, or where such requests seek other information about card 220A.

Computing system 281 may obtain a new transaction hash for card 220A. For instance, still referring to the example being described in the context of FIG. 2, transaction module 293 causes communication unit 285 to output a signal over network 205. One or more nodes 251 on consensus networks 250 detect the signal and determine that the signal corresponds to information about a new transaction being performed using card 220A. One or more of nodes 251 generate a new transaction hash for card 220A, which may summarize and/or be derived from information about all previous transactions performed using card 220A. Nodes 251 within consensus network 250 updates distributed ledger 259 to include the new transaction hash for card 220A. One or more nodes 251 output a signal that is detected by computing system 281. Ledger module 292 of computing system 281 determines that the signal includes the new transaction hash for card 220A.

Computing system 281 may cause card 220A to be updated with the new transaction hash. For instance, continuing with the example being described in the context of FIG. 2, transaction module 293 causes communication unit 285 to output a signal over network 205. Computing device 212A detects the signal and determines that the signal corresponds to information about the new transaction hash for card 220A, which reflects and/or is derived from all the transactions performed using card 220A (including the new transaction taking place between user 210A and merchant 240A). Computing device 212A communicates and/or interacts with card 220A (e.g., pursuant to a wireless protocol, such as near-field communication) to update the transaction hash stored within card 220A.

In the example being described, computing device 212A updates the transaction hash stored within card 220A. However, in other examples, merchant computing system 242A (i.e., as the other party to the transaction) may perform operations to update card 220A when the transaction between user 210A and merchant 240A takes place. In other words, rather than computing device 212A updating card 220A with the new transaction hash, merchant computing system 242A (or some other system) could, alternatively, update card 220A so that the new transaction hash is stored within memory included within card 220A.

In some cases, the intrinsic value of card 220A (i.e., the precious metal included within the card) will match the value of the transaction, meaning that the goods and/or services that user 210A is purchasing from merchant 240A happens to have the same value as the intrinsic value of card 220A. In many examples, however, the value of card 220A will differ from the value of the transaction. For example, where the value of card 220A exceeds the value of the transaction, user 210A would normally be entitled to receive “change” to compensate for the excess value of card 220A. Similarly, where the value of card 220A is less than the value of the transaction, user 210A would normally be expected to use another source of payment to make up the shortfall in payment. Such other source of payment could be another card 220, cash, or other value.

Computing system 281 may facilitate an electronic transfer of funds to account for the difference between card 220A and the value of the transaction. For instance, in an example where the value of card 220A differs from the value of the transaction, computing device 212A and/or merchant computing system 242A output a signal over network 205. Transaction module 293 of computing system 281 receives an indication of a signal and determines that the signal corresponds to a request to perform an electronic funds transfer to reconcile the difference between card 220A and the transaction value. Transaction module 293 accesses information about the user account 298 associated with user 210A and the user account 298 associated with merchant 240A, and performs an electronic funds transfer between the accounts. If the value of card 220A exceeds the value of the transaction, funds in the account held by merchant 240A are transferred to the account held by user 210A. If the value of card 220A is less than the value of the transaction, funds in the account held by user 210A are transferred to the account held by merchant 240A.

It might be expected that some users will attempt to create counterfeit cards for use in transaction network 200. For example, card 220A′, illustrated in FIG. 2, is intended to represent a counterfeit version of card 220A. A counterfeit card may look like and operate similar to a legitimate card 220, and might or might not have some amount of precious metal embedded within it. But in general, a successful counterfeit card 220 will likely need to have a legitimate identification code and/or transaction hash in order to ensure that it is recognized as being legitimate by computing systems within transaction network 200 (e.g., computing system 281, merchant computing systems 242, and/or computing devices 212).

For example, suppose user 210A has possession of a counterfeit card, such as card 220A′. User 210A may have innocently gained possession of card 220A′ from another user 210, or user 210A may know that user 210A′ is counterfeit. In any event, once user 210A has possession of card 220A′, user 210A may attempt to use card 220A′. For instance, in an example of counterfeit card usage that can be described in the context of FIG. 2, computing device 212A detects input that it determines is a request by user 210A to purchase goods or services from merchant 240A, similar to the prior example outlined above. As in the previously-described transaction, a transaction using card 220A′ involves computing device 212A collecting information from card 220A′ (e.g., by interacting with processing circuitry on card 220A′ or by scanning a QR code printed on card 220A′). As in the prior example, computing device 212A collects both an identifying code and a transaction hash for card 220A′. Computing device 212A outputs a signal over network 205 that transaction module 293 of computing system 281 determines is a request to perform a transaction using a card 220.

In some examples, computing system 281 may refuse the transaction if the identification code associated with card 220A′ is not legitimate or is not recognized. For instance, in the example being described above, transaction module 293 determines, based on information received from computing device 212A over network 205, an identification code for card 220A′ and a transaction hash for card 220A′. Transaction module 293 determines whether the identification code is legitimate, such as by determining whether distributed ledger 259 includes information about a valid card with that identification code. If distributed ledger 259 does not include information about the identification code received from computing device 212A, transaction module 293 will generally conclude that card 220A′ is not legitimate, and thereafter will refuse attempts to use card 220A′ in a transaction.

In another example, computing system 281 may refuse the transaction if there are inconsistencies associated with the transaction hash. For instance, if transaction module 293 determines that the identification code associated with card 220A′ is legitimate, transaction module 293 then compares the transaction hash stored on card 220A′ (received from computing device 212A) with the transaction hash stored for that card on distributed ledger 259. If transaction module 293 determines that the transaction hash stored on card 220A′ is not consistent with the transaction hash information for card 220A stored in distributed ledger 259, transaction module 293 will determine that card 220A′ is not legitimate, and will thereafter refuse attempts to use card 220A′ in a transaction.

If, however, the transaction code associated with card 220A′ appears legitimate (i.e., it is consistent with transaction hash information stored in distributed ledger 259 for a known identification code), then transaction module 293 may allow the requested transaction to proceed, as if card 220A′ were legitimate. As a result of the transaction, and in a manner similar to that previously described, both the transaction hash stored in card 220A′ and the transaction hash stored in 259 would be updated to reflect the new transaction.

After counterfeit card 220A′ is used in the transaction with merchant 240A (apparently successfully), further use of card 220A will likely reveal that there is a counterfeit card 220A′ being used within transaction network 200. For instance, the legitimate and non-counterfeit version of card 220A may be used again within transaction network 200, since it may be in the possession of user 210A, or possibly in the possession of another user 210 (e.g., as a result of transactions taking place in transaction network 200). Suppose user 210A still retains the legitimate version of card 220A. In such an example, when user 210A seeks to use card 220A to perform a transaction, computing device 212A will send an identification code and a transaction hash associated with card 220A to computing system 281 (e.g., over network 205). Transaction module 293 of computing system 281 will evaluate the identification code for card 220A and will determine that the identification code is legitimate. However, when transaction module 293 attempts to verify the transaction hash for card 220, transaction module 293 will determine that the transaction hash stored on card 220A is not consistent with the transaction hash information for card 220A stored in distributed ledger 259. The prior fraudulent transaction, where card 220A′ was used, caused the transaction hash stored in distributed ledger 259 for card 220A to be updated, but since the legitimate card 220A was not used in that transaction, the transaction hash stored in legitimate card 220A was not updated (only counterfeit card 220A′ was updated with the new transaction hash). As a result, the transaction hash received from card 220A will not be consistent with the information stored in distributed ledger 259. In this situation, transaction module 293 denies attempts to use card 220A.

In addition, transaction module 293 also denies attempts to use any card having the identification code associated with card 220A (including card 220A′). The effect is that computing system 281 is able to stop further use of counterfeit card 220A′, and any card that purports to be card 220A. In some examples, network administrator 280 may flag card 220A and launch an investigation and attempt to remedy the effect of the illegitimate transactions. Such an effort may involve tracing prior transactions to their source and/or users 210, reversing one or more transactions, possibly reversing or modifying entries in distributed ledger 259, creating a fork in distributed ledger 259, and/or affecting or adjusting the network status of one or more users 210 on transaction network 200.

As described herein, computing system 281 may manage transactions involving cards 220 via consensus network 250. For example, identity module 291 may, prior to cards 220 being distributed, hash one or more details within memory included each of cards 220. Such details may pertain to the weight and purity of precious metal embedded in the card, information about the universal integrated circuit card embedded in the card, a unique identifier associated with a quick response code or barcode embedded the card, one or more transaction hashes, an image of the card, or other information.

In some examples, one or more of cards 220 may be mapped to an account of accounts module 298. Accounts module 298 may include information about accounts associated with users 210, merchants 240, subscribers, or other participants in transaction network 200.

Computing device 212A may, for example, cause an account to be created for user 210A, which can be used to memorialize that user 210A is the current owner of card 220A. For instance, computing system 281 interacts with computing device 212A, which is operated by user 210A. In response to such interactions, computing device 212A communicates with computing system 281 via network 205. Computing system 281 receives data in response to such communications. Computing system 281 may create or update an account associated with card 220A stored in accounts module 298 to thereby register account data associated with an account managed by user 210A as being associated with card 220A. Computing system 281 may also receive, from computing device 212A, data about other accounts. In response to receiving such data, computing system 281 may securely link such other accounts (e.g., bank accounts, cryptocurrency wallets, etc.) to the accounts managed by accounts module 298 on behalf of user 210A.

In some instances, a card of cards 220 may be used to purchase a product or service that costs less than the monetary value of the card of cards 220. In such instances, the party (e.g., merchant 240A) can return any excess payment (i.e., change) in the form of an electronic funds transfer. For example, user 210A may use card 220A in a transaction with merchant 240A. Merchant 240A may agree to exchange card 220A for merchandise. If the value of the merchandise is less than the value of card 220A, merchant 240A causes merchant computing system 242A to transfer funds that exceed the value of the merchandise to an account owned by user 210A.

Computing system 281 may process a request to authenticate one of cards 220 by comparing the information received from the card 220 and/or the image received from a computing device 212 (or merchant computing system 242) to the details of that card 220 that are included in the set of data managed by consensus network 250 for that card. Computing system 281 may also validate an encryption key stored in the card 220. Computing system 281 may additionally map the encryption key in processing circuitry included in the card 220 to data associated with the card 220 prior to issuance of the card 220. In some examples, a computing device 212 (or merchant computing system 242) may capture an image of the card and include the image, along with a timestamp, in the request to authenticate card 220.

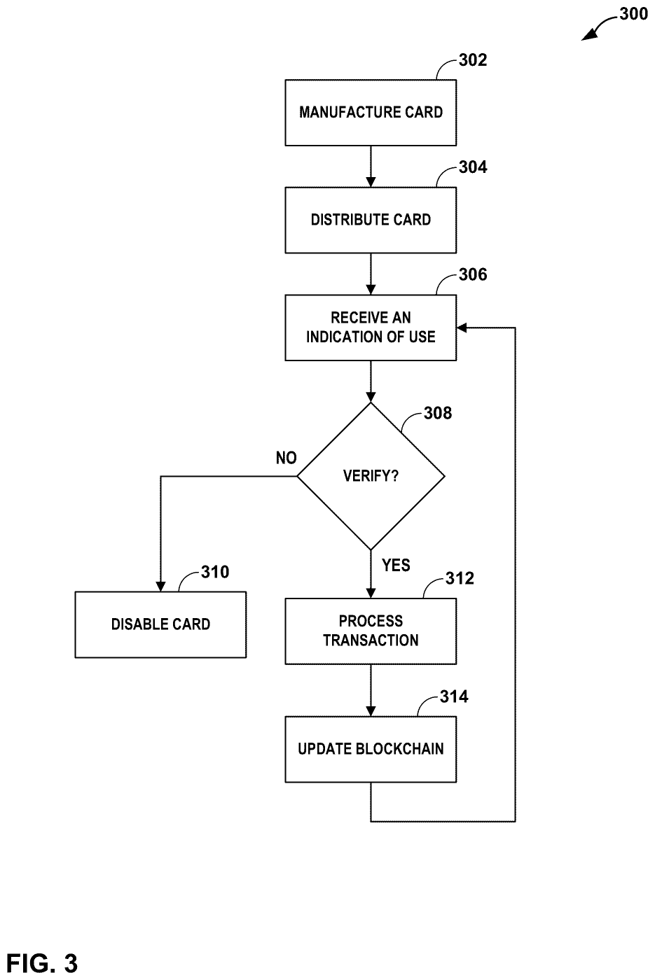

FIG. 3 is a flow diagram illustrating example operations performed for or in a transaction network in accordance with one or more aspects of the present disclosure. FIG. 3 is described herein with reference to FIG. 1. In other examples, operations described in FIG. 3 may be performed by one or more other components, modules, systems, or devices. Further, in other examples, operations described in connection with FIG. 3 may be merged, performed in a different sequence, omitted, or may encompass additional operations not specifically illustrated or described.

Network administrator 180, for example, may manufacture precious metal cards (e.g., card 120) (302). For example, network administrator 180 manufactures card 120 by embedding precious metal within the card. Network administrator 180 may also embed processing circuitry within the card, and store an identification code within the processing circuitry. Network administrator 180 may also cause computing system 181 to store one or more details of card 120 in distributed ledger 159 maintained by consensus network 150.

Network administrator 180 may distribute one or more cards 120 to users 110 (304). For example, network administrator 180 places a card 120 in circulation by exchanging the card for other forms of value (e.g., cash) furnished by one of users 110. In some examples, as part of placing the card 120 in circulation, computing system 181 may cause changes to be logged to distributed ledger 159, reflecting ownership of the card. Computing system 181 may also, based on input received from a user 110, manage a chain of title for the card 120.

Computing system 181 may receive an indication that card 120 is being used (306). For example, a computing device 112 detects input and outputs an indication of the input to computing system 181 over network 105. Computing system determines that the input corresponds to a request to perform a transaction between a user 110 and a merchant 140.

Computing system 181 may verify the authenticity of card 120 (308). For example, computing system 181 outputs a signal over network 105 that computing device 112 determines is a command to present a user interface. Computing device 112 presents a user interface, prompting user 110 to connect card 120 to a power source and/or a merchant computing system 142. Card 120 connects to user device 112 and communicates, through user device 112, a signal over network 105 to computing system 181. Computing system 181 detects the signal and analyzes information included within the signal (e.g., an identification code and any transaction hash that was stored in card 112). In some examples, the signal also includes other attributes of card 120, including information about diagnostic tests executed on card 120 (e.g., electrical current tests or voltage drop information). Computing system 181 compares the identification code and transaction hash to data stored in distributed ledger 159 maintained by consensus network 150. Based on the comparison and, possibly, evaluation of other information, computing system 181 may verify card 120.

In response to computing system 181 determining card 120 is not verified, computing system 181 may disable card 120 (310, and NO path from 308). For example, computing system 181 may determine that the identification code and/or transaction hash that was stored in card 120 is not consistent with the information about card 120 stored in distributed ledger 159. In that situation, computing system 181 causes consensus network 150 to update distributed ledger 159 with a new transaction hash, potentially creating a fork in the blockchain maintained by nodes 151. Computing system 181 may also refuse to validate card 120 and/or refuse to process transactions for card 120. Computing system 181 may flag card 120 for investigation or review by network administrator 180. Computing system 181 may prohibit further transactions involving card 120 until network administrator 180 completes its investigation.

On the other hand, in response to computing system 181 verifying card 120, computing system 181 may process the transaction involving card 120 (312, and YES path from 308). For example, computing system 181 may determine that the identification code and transaction hash that was stored in card 120 is consistent with the information about card 120 stored in distributed ledger 159. Computing system 181 may also determine that other attributes of card 120 support a finding of validity. In that situation, computing system 181 enables the transaction to proceed and generates a new transaction hash.

Computing system 181 may update consensus network 150 with the transaction hash (314). For example, computing system 181 communicates with one or more nodes 151 of consensus network 150, and causes the nodes 151 to update distributed ledger 159 with the new transaction hash for card 120. Computing system 181 also communicates with computing device 112 to cause the new transaction hash to be stored within memory included in card 120.

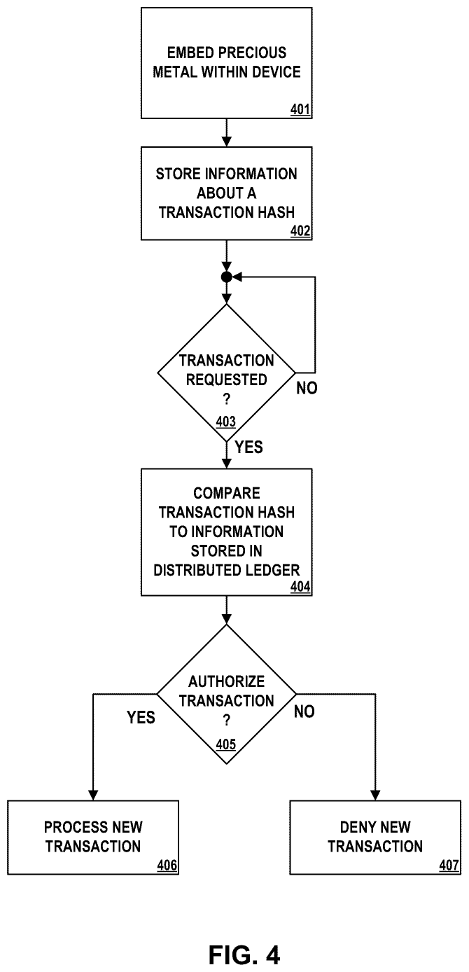

FIG. 4 is a flow diagram illustrating operations performed by an example computing system in accordance with one or more aspects of the present disclosure. FIG. 4 is described below within the context of network management computing system 181 of FIG. 1A. In other examples, operations described in FIG. 4 may be performed by one or more other components, modules, systems, or devices. Further, in other examples, operations described in connection with FIG. 4 may be merged, performed in a different sequence, omitted, or may encompass additional operations not specifically illustrated or described.

In the process illustrated in FIG. 4, and in accordance with one or more aspects of the present disclosure, network administrator 180 may embed precious metal within a device (401). For example, network administrator 180 manufactures (or contracts with another entity to manufacture) one or more devices. In most examples described herein, such devices take the form of cards 120, which may have a form factor similar to common credit cards. Devices, as described herein, could have other form factors, larger or smaller than a common credit card. As part of the manufacturing process, network administrator 180 embeds precious metal within each such card 120, providing an inherent or intrinsic value to each card, which may enable each of cards 120 to be used as physical currency.

In addition, network administrator 180 may also embed processing circuitry into the card (e.g., a system on a chip or “SoC”). Network administrator 180 further associates an identification code with each of cards 120, thereby enabling each card to be uniquely identified. In some examples, the identification code is stored within memory included within each card (e.g., within the SoC) or is otherwise embedded and/or integrated into processing circuitry included within each card. Alternatively, or in addition, network administrator 180 may cause a computer-readable code (e.g., a QR code) to be printed on the face of each card during manufacturing, which can later be used to determine the identification code associated with the card. Still further, network administrator 180 may also, as part of the manufacturing process, embed an initial transaction hash into each card (e.g., within memory included within the card's processing circuitry).

Computing system 181 may store information about a transaction hash device (402). For example, network management computing system 181 may output a signal over network 105. One or more nodes 151 on consensus network 150 detect the signal and determine that the signal corresponds to a request to store information in distributed ledger 159 about one or more cards 120. Nodes 151 follow a consensus protocol and eventually agree about the information to be stored within distributed ledger 159. In some examples, the stored information includes the identification code and the current transaction hash associated with each of cards 120. Accordingly, for each such card 120, distributed ledger 159 will have a record of the identification code and the current (or initial) transaction hash for that card.

Network management computing system 181 may wait for a transaction using the device to be requested (403). For example, computing device 112A waits for and eventually detects input. In response, computing device 112A outputs information about the input over network 105 to network management computing system 181. Network management computing system 181 receives the information and determines that the input detected by computing device 112A corresponds to a request, by user 110A, to engage in a transaction with merchant 140A using card 120A. In the same or a separate communication, network management computing system 181 receives from computing device 112A information about card 120A, including the identification code associated with card 120A and the current transaction hash stored within card 120A.

Computing system 181 may compare information about the device to the information stored in the distributed ledger (404). For example, network management computing system 181 interacts with nodes 151 on consensus network 150 to access the transaction hash associated with card 120A that is stored within distributed ledger 159. Network management computing system 181 compares the transaction hash stored within the card to the transaction hash stored within distributed ledger 159.

Computing system 181 may determine whether to authorize the transaction (405). For example, if network management computing system 181 determines that the transaction hash stored within the card and the transaction hash stored on distributed ledger 159 are not consistent, network management computing system 181 may deny the transaction (407 and NO path from 405). However, if network management computing system 181 determines that the transaction hash stored within the card and the transaction hash stored on distributed ledger 159 are consistent, network management computing system 181 may authorize the transaction (YES path from 405).

If authorized, network management computing system 181 may process the transaction (406). For example, network management computing system 181 generates (or causes consensus network 150 to generate) a new transaction hash for card 120A, which reflects the new transaction. Network management computing system 181 communicates with consensus network 150 to cause distributed ledger 159 to be updated to include the new transaction hash for card 120A. Network management computing system 181 also communicates with computing device 112A over network 105 to cause computing device 112A to update card 120A with the new transaction hash. Network management computing system 181 may also perform an electronic funds transfer to reconcile any differences between the value of the transaction and the intrinsic value of card 120A.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses. Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A device comprising:
precious metal embedded within the device providing an intrinsic value for the device and making the device suitable for use as physical currency; and
processing circuitry configured to:
store information about a transaction hash associated with the device, wherein the transaction hash is derived from prior transactions performed using the device, and
enable comparison of the transaction hash to information about the device that is stored on a distributed ledger.

2. The device of claim 1, wherein to enable comparison of the transaction hash to information about the device that is stored on the distributed ledger, the processing circuitry is further configured to:
communicate the transaction hash to a consensus network that maintains the distributed ledger; and
enable the consensus network to compare the transaction hash to the information about the device that is stored on the distributed ledger.

3. The device of claim 2, wherein to enable the consensus network to compare the transaction hash to the information about the device that is stored on the distributed ledger, the processing circuitry is further configured to:
enable a smart contract executing on the consensus network to compare the transaction hash to the information about the device that is stored on the distributed ledger.

4. The device of claim 3, wherein the processing circuitry is further configured to:
enable the smart contract to determine that the transaction hash is consistent with the information about the device that is stored on the distributed ledger; and
enable the smart contract to authorize a new transaction using the device.

5. The device of claim 4, wherein the processing circuitry is further configured to:
store, in memory included within the device, a new transaction hash that is based on the new transaction.

6. The device of claim 3, wherein the processing circuitry is further configured to:
enable the smart contract to determine that the transaction hash is not consistent with the information about the device that is stored on the distributed ledger; and
enable the smart contract to deny the new transaction.

7. The device of claim 1,
wherein the device is in the form of a payment card.

8. The device of claim 1, wherein the processing circuitry comprises a system on a chip having a secure enclave, and wherein to store the information about the transaction hash, the processing circuitry is further configured to:
store the information about the transaction hash in the secure enclave.

9. The device of claim 1,
wherein the precious metal is of a purity less than bullion-level purity.

10. The device of claim 1,
wherein the precious metal embedded within the device has a weight exceeding a tenth of an ounce.

11. The device of claim 1,
wherein the precious metal embedded within the device has a weight exceeding a hundredth of an ounce.

12. A method comprising:
embedding precious metal within a device, thereby providing the device with an intrinsic value and making the device suitable for use as physical currency;
storing, within the device, information about a transaction hash associated with the device, wherein the transaction hash is derived from prior transactions performed using the device;
detecting an indication of a new transaction; and
comparing the transaction hash to information about the device that is stored on a distributed ledger.

13. The method of claim 12, wherein comparing the transaction hash to information about the device that is stored on the distributed ledger includes:
communicating the transaction hash to a consensus network that maintains the distributed ledger; and
enabling the consensus network to compare the transaction hash to the information about the device that is stored on the distributed ledger.

14. The method of claim 13, wherein enabling the consensus network to compare the transaction hash to the information about the device that is stored on the distributed ledger includes:
enabling a smart contract executing on the consensus network to compare the transaction hash to the information about the device that is stored on the distributed ledger.

15. The method of claim 14, wherein the method further comprises:
enabling the smart contract to determine that the transaction hash is consistent with the information about the device that is stored on the distributed ledger; and
enabling the smart contract to authorize a new transaction using the device.

16. The method of claim 15, wherein the method further comprises:
storing, in memory included within the device, a new transaction hash that is based on the new transaction.

17. The method of claim 14, wherein the method further comprises:
enabling the smart contract to determine that the transaction hash is not consistent with the information about the device that is stored on the distributed ledger; and
enabling the smart contract to deny the new transaction.

18. The method of claim 12,
wherein the device is in the form of a payment card.

19. The method of claim 12, wherein the device comprises a system on a chip having a secure enclave, and wherein storing the information about the transaction hash includes:
storing the information about the transaction hash in the secure enclave.

20. A non-transitory computer-readable medium comprising instructions that, when executed, configure processing circuitry of a computing system to:
store, within a device in which precious metal is embedded, information about a transaction hash associated with the device, wherein the transaction hash is derived from prior transactions performed using the device;
detect an indication of a new transaction; and
compare the transaction hash to information about the device that is stored on a distributed ledger by communicating the transaction hash to a consensus network that maintains the distributed ledger.
